(19) United States
(12) Patent Application Publication
(10) Pub. No.: US 2024/0295234 A1
(43) Pub. Date: Sep. 5, 2024

(54) RETAINING CLIP

(71) Applicant: GRAMMER Aktiengesellschaft, Ursensollen (DE)

(72) Inventors: Manfred LINK, Mudau (DE); Rico HANITZSCH, Ilmmünster (DE)

(73) Assignee: GRAMMER Aktiengesellschaft, Ursensollen (DE)

(21) Appl. No.: 18/403,998

(22) Filed: Jan. 4, 2024

(30) Foreign Application Priority Data
Mar. 1, 2023 (DE) 10 2023 105 023.0

(51) Int. Cl. F16B 21/07

(52) U.S. Cl. CPC F16B 21/075

(57) ABSTRACT

A retaining clip for fastening a pin-like first part in an opening of a second part includes a spring elastic base body with a U-shaped recess for receiving the pin-like first part and with two side legs delimiting the recess. A first and a second inner side arm form an apex of the U-shaped recess. An end of the first inner side arm is connected to an end of a first outer side arm. An end of the second inner side arm is connected to an end of a second outer side arm. A second end of the first outer side arm and a second end of the second outer side arm each project laterally into the U-shaped recess in the region of its apex with the outer side of an arcuate section.

### CROSS REFERENCE TO RELATED APPLICATION

This application claims the benefit of German Patent Application No. 10 2023 105023.0, filed Mar. 1, 2023, the contents of which are incorporated herein by reference in its entirety.

### FIELD

The invention relates to a retaining clip for fastening a pin-like first part in an opening of a second part.

### BACKGROUND

Such a retaining clip is known, for example, from DE 20 2021 003 158 U1. With this retaining clip, which can be used, for example, for fastening various components in the interior of a vehicle, wherein the components should also be detachable from the mounting point, a pin-like first part, which is connected to a component to be mounted, is often clicked into an opening of a second part, that is the part to which the component is to be fastened, with the aid of the clip. For this purpose, the pin-like first part is inserted into a substantially U-shaped recess and is to be held by the clip. However, since such a retaining clip has no further fastenings other than the side arms of the U-shaped recess, particularly in its lower area, that is in the area of its apex of the U-shaped recess, stabilization of the pin-like first component is not ensured, particularly at its front end.

### SUMMARY

It is therefore the object of the invention to provide a retaining clip for fastening a pin-like first part in an opening of a second part, which ensures a stabilized arrangement of the first part within the retaining clip without damaging that part and a release of the retaining clip from this pin-like first part.

This object is solved in accordance with the features described herein.

Such a retaining clip according to the invention for fastening a pin-like first part in an opening of a second part comprises:
a spring-elastic base body with a centrally arranged, substantially U-shaped recess for receiving the pin-like first part
and with two side legs delimiting the recess,
wherein the first side leg comprises a first inner side arm and a first outer side arm and the second side leg comprises a second inner side arm and a second outer side arm.

The first and second inner side arms are connected to each other at their first ends, forming an apex of the U-shape of the U-shaped recess. A second end of the first inner side arm is connected to a first end of the first outer side arm, forming an inflection point. A second end of the second inner side arm is connected to a first end of the second outer side arm, forming an inflection point. A essential point of the invention is to allow a second end of the first outer side arm and a second end of the second outer side arm to each project laterally into the U-shaped recess in the region of its apex with the outside of an arched section, so that although a slightly spring-loaded compression of the first pin-shaped element takes place in its side area, no damage occurs in this area due to any hooks or clips. This compression ensures that the pin-like part remains stabilized in the front-end region within the retaining clip and within the U-shaped recess, wherein it can be additionally locked in the further course against unintentional slipping out with spring element hooks.

Preferably, the arched sections are formed in such a way that they protrude laterally and convexly into the recess in an opposite and mirror-symmetrical manner, so that the outer sides of the arcuate section against the lateral outer surfaces of the pin-like first part.

The arched sections can be moved in an orthogonal direction to the course of the surfaces, in particular the longitudinal surfaces, of the inner side arms and can be spring-loaded in order to cause the arched sections to yield and thus release the recess in the front-end region, i.e. at its apex, for the pin-like first part to be inserted.

A first width extension of the arched sections is provided in each case with a length which is less than the length of a second width extension of the first and second side arms, although the arched sections form a continuation or a lower section of the first and second outer side arms.

The arched sections are each arranged in a pass-through opening of the first and second inner side arms so as to be able to act on the outer sides of the pin-like first part by engaging through the inner side arm walls.

The first spring element hooks, which project laterally into the U-shaped recess at a distance from the arcuate sections, are provided for additionally holding the pin-like first part. These first spring hooks can be aligned in such a way that they point in the direction of insertion of the pin-like first part to be inserted and act against this direction of movement when the pin-like first part is unintentionally pulled out.

Preferably, the first spring element hooks are arranged on the edge of the inner side arms with respect to a third width extension of the first and second inner side arms. This means that the spring element hooks do not extend over the entire width of the inner side arms, but are only arranged in the edge area in each case. This means that two first spring element hooks would be arranged on each side, i.e. on each inner side arm. This has the effect that the formation of a total of four first spring element hooks ensures stable locking of the pin-like first part within the U-shaped recess, even in the event of unintentional pivoting of the pin-like first part.

According to a preferred embodiment, second spring element hooks are provided, which also project into the U-shaped recess, at a distance from the first spring element hooks. These second spring element hooks also project in laterally and, in relation to a third width extension of the first and second inner side arms, are arranged in the middle area on the inner side arms. The fact that these second spring element hooks are arranged in the central region and the first spring element hooks are arranged in the edge region results in a supplement in the effect of holding the pin-like first part. This is because the pin-like first part is now held on its side in the middle region by the upper second spring element hooks and in the edge region by the lower first spring element hooks. The second spring element hooks can also be aligned in the insertion direction in relation to the pin-like first element, so that they hook when the pin-like first part is pulled out unintentionally.

The first and second inner side arms are formed, preferably in one piece, in such a way that each arched section arranged thereon forms an S-shaped path together with a curved section of the first and second inner side arms. This makes it easy to manufacture the advantageously formed arched sections by bending the first and second inner side arms in one piece first in one direction and then in the other direction.

According to a preferred embodiment, a first outer arm arranged outside the first outer side arm and a second outer arm arranged outside the second outer side arm are provided, which are elastically movable in an orthogonal direction to a longitudinal axis of the retaining clip and have the object of holding the clip in the opening of the second part in a stabilized manner, so that a stable and permanent, but detachable, connection between the first and second part is possible.

Further advantageous embodiments are shown in the sub-claims.

Advantages and usefulness can be seen from the following embodiments in conjunction with the drawing.

### BRIEF DESCRIPTION OF THE DRAWINGS

The figures show:

FIG. 1A side view of a center frame I-panel as an example of the use of the retaining clips according to the invention in the automotive sector;

FIG. 2 is a perspective view of the retaining clip according to the invention;

FIG. 3 a front view of the retaining clip according to the invention according to one embodiment;

FIG. 4 a sectional view along the line B-B, as indicated in FIG. 3;

FIG. 5 a side view of the retaining clip according to the invention according to one of the preferred embodiments;

FIG. 6 a sectional view along the line A-A, as indicated in FIG. 5;

FIG. 7 a top view of the retaining clip according to the invention;

FIG. 8 a sectional view of the retaining clip along the line C-C, as indicated in FIG. 7.

### DETAILED DESCRIPTION

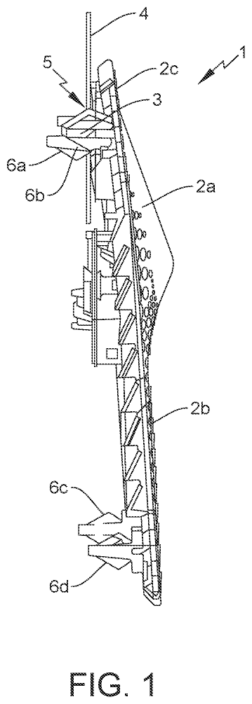

FIG. 1 shows a side view of a center frame I-panel, as is frequently installed in motor vehicles. This requires retaining clips which are used to release the center frame, for example to replace it if it is damaged.

Such a center frame I-panel 1 has various surface sections, operating elements etc. 2a, 2b and 2c on its surface and is held in place in openings of a further component 4 by the clips shown. In this illustration, only a section of a console part 4 with an opening 5, in which the center frame is to be arranged, is shown as an example.

A first part, which can be formed like a pin, is arranged according to reference sign 3 within an substantially U-shaped recess of the retaining clip and is connected at its other end to the center frame or is part of this center frame. A total of four retaining clips 6a, 6b, 6c and 6d are shown in this illustration.

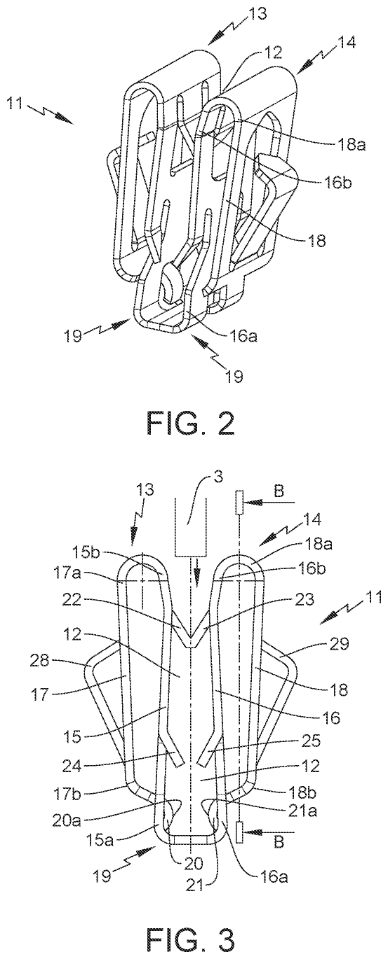

In FIG. 2, which shows a perspective view of a retaining clip according to the invention, and in FIG. 3, which shows a front view of the retaining clip according to the invention as shown in FIG. 2, the structure and function of such a retaining clip 11 is described in more detail.

It can be seen from both FIG. 2 and FIG. 3 that a substantially U-shaped recess 12 is present between two side legs 13, 14 delimiting the recess, the latter having a kind of apex 19 in the lower region of recess 12.

A first side leg 13 has a first inner side arm 15 and a first outer side arm 17 and the second side leg has a second inner side arm 16 and a second outer side arm 18. The first and second inner side arms are connected to each other at their first ends 15a and 16a, forming the apex 19 of the U-shape of the U-shaped recess 12. This can be seen in the lower region of the illustrations by the reference sign 19.

The side arms, which, like the remaining components, can be of sheet metal-like design, and are therefore arranged to the left and right of the U-shaped recess 12. A slight inward inclination of the two inner side arms 15 and 16 in the upper region serves to achieve a stabilizing effect on a pin-like first part 3 after its insertion into the U-shaped recess 12. At the same time, spring element hooks 24, 25 and in particular 22, 23 can engage in these side surfaces of the pin-like first part 3 to stabilize it against unintentional slipping out again.

The first inner side arm 15 is connected by its second end 15b in the upper area, forming an inflection point, to a first end 17a of the first outer side arm 17. Similarly, the second inner side arm 16 is connected by its second end 16b in the upper region to a first end 18a of the second outer side arm 18 in such a way that an inflection point or a turning arch is also obtained in this area, preferably in one piece.

In addition, a first outer arm 28 and a second outer arm 29 are spring-loaded in such a way that they have a stabilizing effect for the retaining clip 11 within the opening 5 when the retaining clip is inserted into the opening 5 of the second part 4. This can also be seen in the illustration according to FIG. 8.

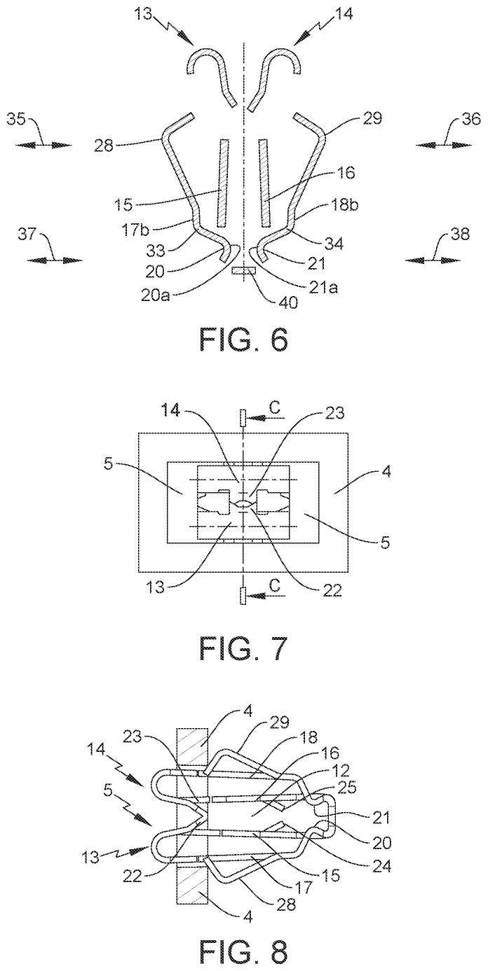

A significant point of the retaining clip according to the invention can be seen in arched sections 20 and 21, which are arranged in the lower area of the retaining clip 11 and extend convexly from the left and right laterally into the U-shaped recess. Due to the spring effect of the outer side arms 17, 18, which is created by the aforementioned inflection points in the upper area of the transition of the outer side arms to the inner side arms, these arched sections 20, 21 can be moved outwards and inwards and subjected to force, as indicated by the double arrows 37 and 38 in FIG. 6 with regard to the direction of movement.

These arched sections 20 and 21 have convex outer surfaces 20a and 21a, which lie closely against the outer side surfaces of the pin-like first part 3 in order to stabilize it in the front-end region, i.e. in the lower region of the U-shaped recess.

Thus, the arched sections can be moved according to the double arrows 37 and 38 in an orthogonal direction to a lateral longitudinal course of the inner and outer side walls.

The additionally arranged spring element hooks 24, 25 and 22, 23 also serve to stabilize the pin-like first part.

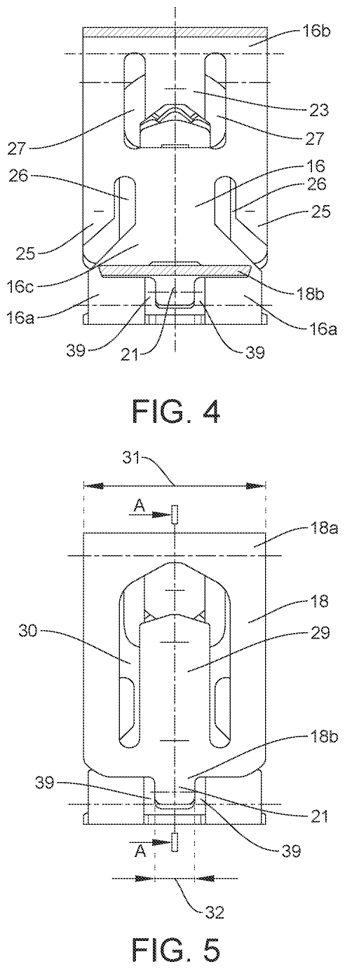

FIG. 4 shows a sectional view of the retaining clip according to section B-B, as indicated in FIG. 3. It can be seen from this illustration that the inner side arm 16, like the other side arms, is flat and has a funnel-shaped course in its lower area 16c, that is in the direction of the first end 16a. This funnel-shaped course has a recess 39 in the center of the lower region, through which the arcuate section 21 can protrude in order to be able to act on the lateral surface of the pin-like first part 3.

Likewise, the inner side arm 16 has further recesses 26 in its surface course in the lateral area approximately in the lower half, viewed from top to bottom, in order to be able to form the spring element hooks 24, 25, which project in the insertion direction and into the U-shaped recess according to FIG. 3, in a separated manner. In this way, these hooks 25 can be bent inwards out of the sheet metal element course of the inner side arm 16 and are thus formed in one piece with the inner side arm 16.

A further recess 27 is provided in order to allow the spring hook element 23 in the upper region, also formed in one piece with the remaining inner side arm 16 or this wall element, to project inwards through this opening in the region of the U-shaped recess.

FIG. 5 shows a side view of the retaining clip. The retaining clip according to this embodiment has a width extension with a length 31, which also relates to the outer side arms and in certain area to the inner side arms. However, the outer side arm 18 shown here is advantageously formed in such a way that, like the outer side arm 17, it has a greater width with length 31 in the upper area than in the lower area with a length 32 of the width extension. This lower area, or the area representing the arched section 21, is somewhat narrower than the upper area with the length 31, so that this width extension with the length 32 can protrude through the recess 39 of the inner side arm 16 into the U-shaped recess. This is present in the lower area or at the second end 18b of the outer side arm 18 as well as in the lower area or at the second end 17b of the outer side arm 17.

In FIG. 6, a cross-sectional representation is shown in a sectional representation A-A, as shown in FIG. 5.

In this cross-sectional view according to FIG. 6, the two side arms 13, 14 can be seen again. Due to the recesses in the side arms already partially described, the illustration shown here only appears with individual sections that are drawn in a disjointed manner. Essentially, the corresponding sections of the inner side arms 15, 16 and the outer side arms 17, 18 are again shown with the respective lower or second ends 17b and 18b. In addition, the outer arms 28 and 29 can be seen which, according to the double arrows 35, 36, can be moved elastically or spring-loaded in an orthogonal direction to the longitudinal axis of the retaining clip in order to ensure a fixed arrangement of the retaining clip within an opening 4 of a second part 5.

In this illustration it can be clearly seen that in the lower area the outer side arms 17, 18 are deformed and formed in such a way that they have an S-shaped configuration, at least when viewed in cross-sectional view. The first S-shaped course is composed of the arched section 20 and an adjoining curved section 33, which then merges into the remaining part of the outer side arm 17. The arched section 21 is also formed by a curved section 34 that is bent or runs in the opposite direction to an S-shape of the outer side arm 18. This S-shape of the two outer side arms in the lower region results in simple manufacture and can also lead to a spring-like effect in the orthogonal direction according to the double arrows 37 and 38 if the shape is correct.

In addition, a base region, or an apex region of the U-shaped recess 12 is shown with the reference sign 40.

FIG. 7 shows a top view of the clip according to the invention. Also shown is the second part 4, which has the recess 5 in which the retaining clip is to be arranged together with a pin-like first part. The rectangular opening 5 of the first part 4 can be seen in this illustration. The two side legs 13 and 14 can also be seen from a topview. Second spring element hooks 22 and 23 are shown when viewed from above.

In FIG. 8, a cross-sectional representation is shown along a section C-C according to FIG. 7. Again, the second part 4 is shown with its opening 5, in which the retaining clip is arranged. First and second spring element hooks 22, 23 and 24, 25 are also shown. Retention of the retaining clip by the outer arms 28, 29 is shown in this representation.

All the features disclosed in the application documents are claimed to be essential to the invention, provided that they are new, either individually or in combination, compared with the prior art.

### LIST OF REFERENCE SIGNS

1 Center frame I-panel
2a Operating element
2b Operating element
2c Operating element
3 Pin-like first part
4 First part/second part/component/console part/opening
5 Opening/second part/recess
6a Retaining clip
6b Retaining clip
6c Retaining clip
6d Retaining clip
11 Retaining clip
12 U-shaped recess
13 First side leg
14 Second side leg
15 First inner side arm
15a First end
15b Second end
16 Second inner side arm
16a First end
16b Second end
16c Lower area
17 Outer side arm
17a First end
17b Second end
18 Outer side arm
18a First end
18b Second end
19 Apex
20 Arched section
20a Convex outer surfaces
21 Arcuate section
21a Convex outer surfaces
22 Second spring element hook
23 Spring element hook/spring hook element
24 Spring element hook
25 Spring element hook/hook
26 Recess
27 Recess
28 First outer arm
29 Second outer arm
31 Length
32 Length
33 Curved section
34 Deflect curved section
35 Double arrow
36 Double arrow
37 Double arrow
38 Double arrow
39 Recess
40 Base region

What is claimed is:

1. A retaining clip for fastening a pin-like first part in an opening of a second part, comprising:
a spring elastic base body with a centrally arranged substantially U-shaped recess for receiving the pin-like first part and with two side legs delimiting the recess, wherein the first side leg comprises a first inner side arm and a first outer side arm and the second side leg comprises a second inner side arm and a second outer side arm, wherein the first and second inner side arms, forming an apex of the U-shape of the U-shaped recess, being connected to each other at their first ends and a second end of the first inner side arm, forming an inflection point, being connected to a first end of the first outer side arm,
and a second end of the second inner side arm, forming an inflection point, being connected to a first end of the second outer side arm,
wherein
a second end of the first outer side arm and a second end of the second outer side arm each project laterally with the outer side of an arched section into the U-shaped recess in the section of its apex.

2. The retaining clip according to claim 1,
wherein
the arched sections project into the recess in a convex shape opposite one another and with mirror symmetry.

3. The retaining clip according to claim 1,
wherein
the arched sections are movable in an orthogonal direction to the surface course of the inner side arms and can be spring-loaded.

4. The retaining clip according to claim 1,
wherein
the arched sections each comprise a first width extension, the length which is less than the length of a second width extension of the first and second outer side arms.

5. The retaining clip according to claim 1,
wherein
the arched sections are each arranged in a pass-through opening of the first and the second inner side arm.

6. The retaining clip according to claim 1,
wherein
first spring element hooks projecting laterally into the U-shaped recess beyond the arched sections to retain the pin-like first part.

7. The retaining clip according to claim 6,
wherein
the first spring element hooks, relative to a third width extension of the first and second inner side arms, are arranged on the edge of the inner side arms.

8. The retaining clip according to claim 1,
wherein
second spring element hooks, which project laterally into the U-shaped recess above the first spring element hooks and, with respect to a third width extension of the first and second inner side arms, are arranged in the central section on the inner side arms.

9. The retaining clip according to claim 1,
wherein each arched section forms an S-shaped course together with an adjacent curved section of the first and second inner side arms.

10. The retaining clip according to claim 1,
wherein a first outer arm arranged outside the first outer side arm and a second outer arm arranged outside the second outer side arm, which are each elastically movable in a direction orthogonal to a longitudinal axis of the retaining clip.
